(19) United States
(12) Patent Application Publication
(10) Pub. No.: US 2016/0248109 A1
(43) Pub. Date: Aug. 25, 2016

(54) DRIVEN ELECTROCHEMICAL CELL FOR ELECTROLYTE STATE OF CHARGE BALANCE IN ENERGY STORAGE DEVICES

(71) Applicant: LOCKHEED MARTIN ADVANCED ENERGY STORAGE, LLC, Bethesda, MD (US)

(72) Inventors: Arthur J. ESSWEIN, San Francisco, CA (US); John Goeltz, Carmel, CA (US)

(21) Appl. No.: 15/027,229

(22) PCT Filed: Oct. 28, 2014
(86) PCT No.: PCT/US2014/062549

§ 371 Date: Apr. 4, 2016

Related U.S. Application Data
(60) Provisional application No. 61/898,750, filed on Nov. 1, 2013.

(51) Int. Cl. H01M 8/06; H01M 8/1023; H01M 8/1039; H01M 8/18

(52) U.S. Cl. CPC H01M 8/06; H01M 8/188; H01M 8/1023; H01M 8/1039; H01M 2008/1095

(57) ABSTRACT

The invention concerns redox flow batteries comprising one or more electrochemical cells in fluid contact with an electrochemical balancing cell, the balancing cell comprising: (i) a first electrode comprising a gas diffusion electrode and the first electrode comprising a hydrogen oxidation catalyst, wherein the first electrode being maintained at a potential more positive than the thermodynamic potential for hydrogen evolution; (ii) a second electrode, the second electrode contacting negative electrolyte, and the second electrode being maintained at a potential sufficiently negative to reduce the negative electrolyte; (iii) a membrane dis posed between the positive electrode and the negative electrode, the membrane suitable to allow hydrogen cations to flow from the membrane to the negative electrolyte; and (iv) a means for contacting hydrogen with the first electrode.

### CROSS REFERENCE TO RELATED APPLICATIONS

This application claims benefit of U.S. Patent Application No. 61/898,750 which was filed Nov. 1, 2013, the disclosure of which is incorporated herein by reference in its entirety.

### TECHNICAL FIELD

The invention concerns energy storage devices having a balancing cell that is useful in balancing energy in electrochemical cells in such devices.

### BACKGROUND

Flow batteries are electrochemical energy storage systems in which electrochemical reactants, typically redox active compounds, are dissolved in liquid electrolytes, which are individually contained in negolyte and posolyte loops and circulated through reaction cells where electrical energy is either converted to or extracted from chemical potential energy in the reactants by way of reduction and oxidation reactions. Especially in larger systems, which may comprise multiple electrochemical cells or stacks, it is important to be able to monitor the state-of-charge of each of the electrolytes, for example to know when the flow battery is “full” or “empty” before actually realizing these end states.

Additionally, for optimal performance, the initial state of such a system provides that the negolyte and posolyte contain equimolar quantities of the redox active species. But after the system has experienced some number of charge/discharge cycles, the posolyte and negolyte may become imbalanced because of side reactions during these operations—for example, generation of hydrogen or oxygen from water if over potential conditions are breached—causing the imbalance and associated loss of performance.

An imbalanced state may be corrected by processing the electrolyte in a balancing cell. But before this can be done, it is necessary to assess the state-of-charge of the system and often the individual electrolytes. State-of-charge for flow batteries is a way of expressing the ratio of concentrations of charged to uncharged active material and can be determined by methods known to those skilled in the art. Once the state of charge is determined, the cells making up the storage devices can be balanced utilizing one or more balancing cells. The present invention provides improved balancing cells and methods for using such cells.

### SUMMARY

The invention concerns redox flow batteries comprising one or more electrochemical cells in fluid contact with an electrochemical balancing cell, the balancing cell comprising: (i) a first electrode comprising a gas diffusion electrode and the first electrode comprising a hydrogen oxidation catalyst, wherein the first electrode being maintained at a potential more positive than the thermodynamic potential for hydrogen evolution; (ii) a second electrode, the second electrode contacting negative electrolyte, and the second electrode being maintained at a potential sufficiently negative to reduce the negative electrolyte; (iii) a membrane disposed between the positive electrode and the negative electrode, the membrane suitable to allow hydrogen cations to flow from the membrane to the negative electrolyte; and (iv) a means for contacting hydrogen-containing gas with the first electrode.

In some embodiments, the hydrogen oxidation catalyst comprises one or more precious metals. In certain embodiments, the precious metal comprises platinum or platinum alloys. Some hydrogen oxidation catalysts comprise one or more precious metals on a carbon support yielding a functionalized carbon material.

With some balancing cells, the second electrode comprises carbon. Preferred second electrodes include those comprising non-functionalized carbon.

In some preferred embodiments, the membrane of the balancing cell is an ion selective membrane. Such a membrane should allow hydrogen cations to flow from the membrane to the negative electrolyte.

Typically, the balancing cell is connected to a power source which supplies energy to the first and second electrodes. The power provided by the power source should be sufficient to drive the balancing cell.

Some hydrogen oxidation catalyst can corrode when used in traditional balancing cell. When used with the balancing cells of the instant invention, the first electrode is preferably maintained at a potential to avoid corrosion of the hydrogen oxidation catalyst in the first electrode.

While any hydrogen source can be used with the instant balancing cell, in some embodiments, the means for contacting hydrogen with the first electrode utilizes hydrogen from head space gas of the electrochemical cell as at least a portion of the hydrogen.

In other embodiments, the invention concerns methods for balancing the state of charge of a flow battery, the method comprising:
obtaining hydrogen-containing gas which optionally may be produced as a by-product of the flow battery;
contacting the hydrogen-containing gas with a first electrode, the first electrode comprising carbon functionalized with a hydrogen oxidation catalyst, and the first electrode being maintained at a potential that is more positive than the thermodynamic potential for hydrogen evolution; and
contacting negative electrolyte with a second electrode, the second electrode being maintained at a potential sufficiently negative to reduce the negative electrolyte; and
applying voltage to the first and second electrodes in an amount sufficient to drive the balancing; wherein
the first and second electrodes being separated by a membrane disposed between the first electrode and the second electrode, the membrane suitable to allow hydrogen cations to flow from the membrane to the negative electrolyte.

Balancing cells described herein can be used with the balancing method. In some preferred embodiments, at least a portion of the hydrogen-containing gas is obtained as a by-product of the flow battery.

### BRIEF DESCRIPTION OF THE DRAWINGS

FIG. 1 presents a schematic of one embodiment of an electrochemical cell of the present invention for balancing electrolyte state of charge (SOC) in a flow battery cell.

FIG. 2 presents a Pourbaix diagram of theoretical domains of corrosion and passivation of platinum at 25° C.

FIG. 3 presents a schematic of a redox flow battery cell without an integrated balancing cell.

FIG. 4 illustrates a battery charge/discharge capacity fade as a result of electrolyte imbalance.

FIG. 5 presents a schematic of a redox flow battery cell with an integrated balancing cell.

FIG. 6 presents battery charge/discharge capacity and balance cell current versus time or cycles.

### DETAILED DESCRIPTION OF ILLUSTRATIVE EMBODIMENTS

The present invention relates to redox flow batteries and methods and apparatuses for monitoring the compositions of the electrolytes (posolyte or negolyte or both) therein. In particular, the present invention relates to redox flow batteries comprising one or more electrochemical cells in fluid contact with an electrochemical balancing cell, the balancing cell comprising: (i) a first electrode comprising a gas diffusion electrode and the first electrode comprising a hydrogen oxidation catalyst, wherein the first electrode being maintained at a potential more positive than the thermodynamic potential for hydrogen evolution; (ii) a second electrode, the second electrode contacting negative electrolyte, and the second electrode being maintained at a potential sufficiently negative to reduce the negative electrolyte; (iii) a membrane disposed between the positive electrode and the negative electrode, the membrane suitable to allow hydrogen cations to flow from the membrane to the negative electrolyte; and (iv) a means for contacting hydrogen with the first electrode.

In some embodiments, the potential of the first electrode is about 5 to about 300 mV more positive than the potential for hydrogen evolution. In certain embodiments, the potential of the second electrode is about 5 to about 300 mV more negative than the reduction potential of the negative electrolyte.

The present invention may be understood more readily by reference to the following description taken in connection with the accompanying Figures and Examples, all of which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer to compositions and methods of making and using the compositions. That is, where the disclosure describes and/or claims a feature or embodiment associated with a system or apparatus or a method of making or using a system or apparatus, it is appreciated that such a description and/or claim is intended to extend these features or embodiment to embodiments in each of these contexts (i.e., system, apparatus, and methods of using).

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

The following descriptions are believed to be helpful in understanding the present invention(s). An electrolyte in a flow battery consists of an active material which can store electrons; the active material thus exists in both a charged state and a discharged (or uncharged) state. If all the active material is discharged the electrolyte is said to have a state of charge of 0%, conversely, if all the active material is in the charged state the state of charge is 100%. At any intermediate state of charge (0%<SOC<100%) there will be a non-zero concentration of both charged active material and discharged active material. When current is passed through an electrode in contact with such an electrolyte, molecules of the active material will either charge or discharge depending on the potential of the electrode. For an electrode of finite area the limiting current density (i_{limiting}) will be proportional to the concentration of the species being consumed by the electrochemical process.

Flow batteries may be described in terms of a first chamber comprising a negative electrode contacting a first aqueous electrolyte; a second chamber comprising a positive electrode contacting a second aqueous electrolyte; and a separator disposed between the first and second electrolytes. The electrolyte chambers provide separate reservoirs within the cell, through which the first and/or second electrolyte flow so as to contact the respective electrodes and the separator. Each chamber and its associated electrode and electrolyte defines its corresponding half-cell. The separator provides several functions which include, e.g., (1) serving as a barrier to mixing of first and second electrolytes; (2) electronically insulating to reduce or prevent short circuits between the positive and negative electrodes; and (3) to provide for ion transport between the positive and negative electrolyte chambers, thereby balancing electron transport during charge and discharge cycles. The negative and positive electrodes provide a surface for electrochemical reactions during charge and discharge. During a charge or discharge cycle, electrolytes may be transported from separate storage tanks through the corresponding electrolyte chambers. In a charging cycle, electrical power is applied to the system wherein the active material contained in the second electrolyte undergoes a one-or-more electron oxidation and the active material in the first electrolyte undergoes a one-or-more electron reduction. Similarly, in a discharge cycle the second electrolyte is reduced and the first electrolyte is oxidized producing electrical power.

In some cases, a user may desire to provide higher charge or discharge voltages than available from a single battery. In such cases, and in certain embodiments, then, several batteries are connected in series such that the voltage of each cell is additive. An electrically conductive, but non-porous material (e.g., a bipolar plate) may be employed to connect adjacent battery cells in a bipolar stack, which allows for electron transport but prevents fluid or gas transport between adjacent cells. The positive electrode compartments and negative electrode compartments of individual cells are suitably fluidically connected via common positive and negative fluid manifolds in the stack. In this way, individual electrochemical cells can be stacked in series to yield a desired operational voltage.

In additional embodiments, the cells, cell stacks, or batteries are incorporated into larger energy storage systems, suitably including piping and controls useful for operation of these large units. Piping, control, and other equipment suitable for such systems are known in the art, and include, for example, piping and pumps in fluid communication with the respective electrochemical reaction chambers for moving electrolytes into and out of the respective chambers and storage tanks for holding charged and discharged electrolytes. The energy storage and generation systems described by the present disclosure may also include electrolyte circulation loops, which loops may comprise one or more valves, one or more pumps, and optionally a pressure equalizing line. The energy storage and generation systems of this disclosure can also include an operation management system. The operation management system may be any suitable controller device, such as a computer or microprocessor, and may contain logic circuitry that sets operation of any of the various valves, pumps, circulation loops, and the like.

In some embodiments, a flow battery system may comprise a flow battery (including a cell or cell stack); storage tanks and piping for containing and transporting the electrolytes; control hardware and software (which may include safety systems); and a power conditioning unit. The flow battery cell stack accomplishes the conversion of charging and discharging cycles and determines the peak power of energy storage system, which power may in some embodiments be in the kW range. The storage tanks contain the positive and negative active materials; the tank volume determines the quantity of energy stored in the system, which may be measured in kWh. The control software, hardware, and optional safety systems suitably include sensors, mitigation equipment and other electronic/hardware controls and safeguards to ensure safe, autonomous, and efficient operation of the flow battery energy storage system. Such systems are known to those of ordinary skill in the art. A power conditioning unit may be used at the front end of the energy storage system to convert incoming and outgoing power to a voltage and current that is optimal for the energy storage system or the application. For the example of an energy storage system connected to an electrical grid, in a charging cycle the power conditioning unit would convert incoming AC electricity into DC electricity at an appropriate voltage and current for the electrochemical stack. In a discharging cycle, the stack produces DC electrical power and the power conditioning unit converts to AC electrical power at the appropriate voltage and frequency for grid applications.

A common issue for flow battery technologies is the maintenance of charge balance between the positive and negative electrolytes. Charge imbalance results from parasitic chemical reactions or membrane crossover phenomena that disproportionally affect one electrolyte over another. Some examples of parasitic reactions that lead to electrolyte charge imbalance are hydrogen evolution and oxidation by oxygen.

Hydrogen evolution can occur in flow batteries when the potential of the negative electrode becomes less than the thermodynamic potential for hydrogen evolution. In this case, hydrogen evolution discharges the negative electrolyte but leaves the positive electrolyte state of charge (SOC) unchanged. This results in a low SOC on the negative side and a higher SOC on the positive side of the redox flow battery. Electrolyte SOC imbalance reduces the energy storage capacity of the flow battery and is therefore highly undesirable. A summary of charge, discharge and parasitic reactions for vanadium and Fe—Cr flow battery chemistries are summarized in Table 1.

TABLE 1
Summary of charge, discharge, and parasitic
reactions for vanadium and Fe—Cr chemistries.

| | Desired Charge/ | |
|---|---|---|
| Chemistry | Discharge Reactions | Parasitic Reactions |
| Vanadium | Positive: VO²⁺ + H₂O [symbol] | 2V²⁺ + 2H⁺ → V³⁺ + H₂ |
| | VO₂⁺ + 2H⁺ + e⁻ | |
| | Negative: V³⁺ + e⁻ [symbol] V²⁺ | 2e⁻ + 2H⁺ → H₂ |
| | | V²⁺ + O₂ → V³⁺ + O₂^{•-} |
| Fe—Cr | Positive: Fe²⁺ [symbol] Fe³⁺ + e⁻ | 2Cr²⁺ + 2H⁺ → 2Cr³⁺ + H₂ |
| | Negative: Cr³⁺ + e⁻ [symbol] Cr²⁺ | 2e⁻ + 2H⁺ → H₂ |
| | | Fe²⁺ + O₂ → Fe³⁺ + O₂^{•-} |
| | | Cr²⁺ + O₂ → Cr³⁺ + O₂^{•-} |

All flow battery chemistries explored to date suffer from electrolyte SOC imbalance. Vanadium flow batteries encounter H₂ evolution with concomitant discharge of the V²⁺ state to V³⁺ at the negative electrode, additionally the V²⁺ species is susceptible to oxidation by O₂ resulting in discharge to the V³⁺ state. Hydrogen evolution is especially problematic for Fe—Cr systems, where by some estimates 1-5% of the current passed in a charge cycle are consumed by hydrogen evolution (see U.S. Pat. No. 5,258,241). For both vanadium and Fe—Cr redox flow batteries, hydrogen evolution and oxidation by O₂ both lead to electrolyte SOC imbalance by discharging the negative electrolyte and leaving the positive electrolyte SOC unchanged. The affects for SOC imbalance may be demonstrated by example of a hypothetical flow battery that requires 100 C of charge to reach 100% SOC. If this battery is charged with 50 C (e.g., 50% SOC) and at this time the potential of the negative electrode becomes such that hydrogen evolution commences and consumes 2% of the current passed at the negative electrode, then for the remaining 50 C balance of the charging cycle the negative electrode will charge at 98% current efficiency and the positive electrode will charge with 100% current efficiency. This means that after 100 C have passed the positive electrolyte will be at 100% SOC and the negative will be at 99% SOC resulting in imbalanced electrolytes. A second charging cycle will yield positive electrolyte at 100% SOC and negative electrolyte at 98% SOC after the passage of 100 C. The electrolyte imbalance will accumulate in this manner with each subsequent cycle. Electrolyte imbalance results in reduced battery capacity, and in the example above, after two cycles the battery capacity is 98% of the original value.

Many concepts have been proposed for electrolyte balancing in redox flow batteries. Some concepts of particular relevance for the present invention relates to the re-oxidation of hydrogen evolved from the negative electrolyte. Concepts proposed in the prior art generally involve the reaction of evolved hydrogen with the positive electrolyte using the reducing power of H₂ to drive the chemical reaction. In this way the SOC of the positive electrolyte can be reduced to match the SOC of the negative electrolyte. For an Fe—Cr system the redox reaction for this process is as follows:

2Fe³⁺+H₂→2Fe²⁺+2H⁺

Direct reactions of H₂ with either Fe³⁺ or VO₂⁺ are sluggish and therefore hydrogen oxidation balancing techniques explored in the art often use precious metal catalysts. These catalysts are typically supported on carbon electrodes such that one section of the electrode is in contact with the gaseous H₂ contained in the electrolyte tank headspace and the other is in contact with the solution of positive electrolyte. The configurations take the form of either a typical electrochemical stack (see U.S. Pat. Nos. 4,159,366 and 5,258,241) or in some cases the electrode is allowed to float on the surface of the positive electrolyte (see Whitehead et. al., J. Power Sources 2013, 230, 271-276).

The exposure of precious metal catalyst to the high potentials and high ionic strengths of the positive electrolyte can induce corrosion of the catalyst materials. Corroded precious metals in the positive electrolyte can then migrate to the negative electrodes where they will plate on the electrode and serve as very efficient catalysts for hydrogen evolution. If this occurs the hydrogen evolution rates at the negative electrode will increase serving to greatly exacerbate electrolyte imbalance.

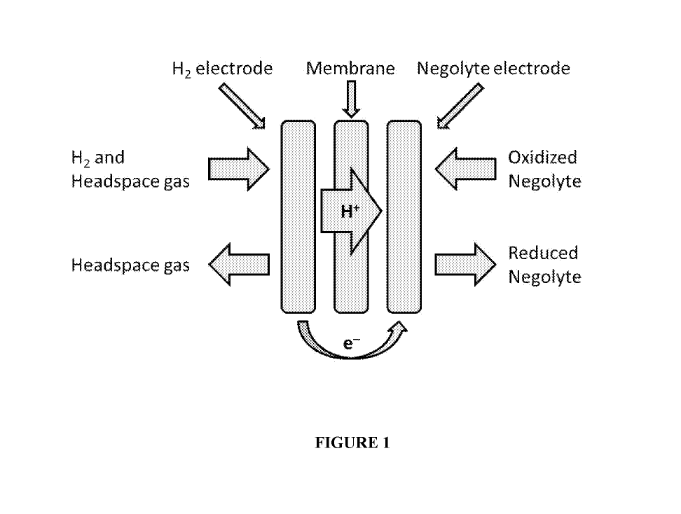

To combat these problems, in some embodiments, the present invention concerns an electrochemical cell (or stack), wherein one electrode is composed of carbon functionalized with an hydrogen oxidation catalyst (such as a precious metal catalyst including a Pt—C electrode), a second electrode that is composed of non-functionalized carbon, and an ion selective membrane disposed between the two electrodes. FIG. 1 shows a schematic of one such cell. It should be understood that FIG. 1 depicts a specific, non-limiting embodiment of a flow battery. Accordingly, devices according to the present disclosure may or may not include all of the aspects of the system depicted in FIG. 1. In this configuration the hydrogen containing gas would come into contact with the precious metal functionalized carbon electrode and the negative electrolyte would come into contact with the bare carbon electrode. A voltage bias would be applied across the electrodes such that the potential of the Pt—C electrode is at all times more positive than the thermodynamic potential for H₂ evolution and the negative electrode is at a potential sufficiently negative to affect reduction of the negative electrolyte. In this way the balancing cell would act to reverse the parasitic hydrogen evolution reaction. It can be understood by one of ordinary skill in the art that the parasitic hydrogen evolution reaction can occur either from the electrode itself (abbreviated “e⁻” below) or in a direct reaction with charged negolyte (abbreviated “Neg” below). For the purposes of the present invention the precise mechanism by which hydrogen is produced (at the electrode or in reaction with the negolyte) is not of material concern, in either case the parasitic reactions result in SOC imbalance between the flow battery posolyte and negolyte and can be corrected by the present invention.

### Parasitic Reactions:

2Neg+2H⁺→2Neg⁺+H₂

2e⁻+2H⁺→2Neg⁺+H₂

### Balance Reaction:

2Neg⁺+H₂→2Neg+2H⁺

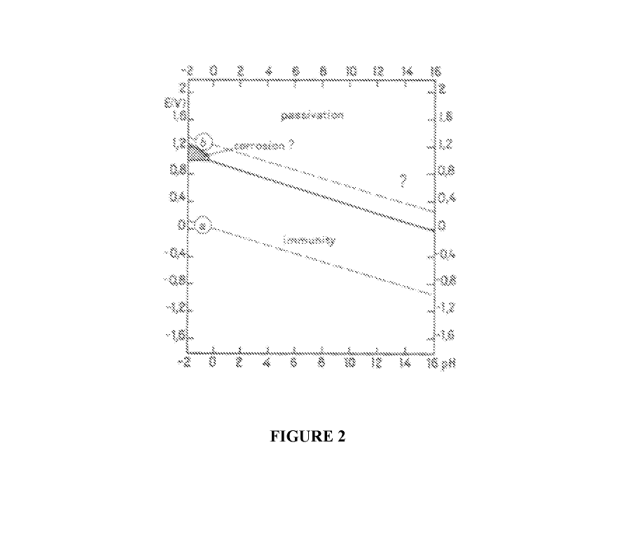

Without being bound by the correctness of any theory, the present invention prevents corrosion of the Pt—C electrode by maintaining the potential at the hydrogen oxidation electrode (e.g. a Pt—C electrode as a non-limiting example) negative with respect to the corrosion potential of that hydrogen oxidation electrode. This results in the hydrogen oxidation electrode encountering an environment where corrosion is thermodynamically prohibited, i.e. the “immunity” regime as commonly described in the Pourbaix diagrams. FIG. 2 presents the Pourbaix diagram for platinum as an example showing corrosion, passivation, and immunity regimes. Similar diagrams may be prepared by one of ordinary skill in the art for other hydrogen oxidation catalysts including platinum alloys and non-precious metal containing catalyst materials.

Under immunity type conditions, metal corrosion rates are predicted to be near zero, and therefore crossover of corroded precious metals to the electrode in contact with the negative active material will not occur. Therefore the excellent hydrogen oxidation capabilities of precious metal electrodes can be employed without concern for exacerbation of parasitic hydrogen evolution reactions.

The instant strategy for electrolyte balancing presents several advantages over other methods: a potential bias across the electrodes provides a simple means of controlling the cell, the precious metal corrosion can be avoided by maintaining potentials on the metal carbon electrode (Pt—C in some embodiments) to potentials wherein corrosion is minimal (e.g. the immunity regime) at all times. Additionally, this strategy can also be employed to mitigate SOC imbalance resulting from oxidation of the negative electrolyte by oxygen or other deleterious reactions. This can be accomplished, by way of a non-limiting example, by introducing hydrogen into the negative electrolyte tank headspace at rates commensurate with oxygen intrusion into the battery system.

In some embodiments, the hydrogen oxidation catalyst comprises one or more precious metals. Precious metal used in such electrodes include Pt, Gd, Ag, Ru, Rh or their alloys. In certain embodiments, the precious metal comprises platinum. In some embodiments, the hydrogen oxidation catalyst is a platinum alloy. In some embodiments the alloying metal is a transition metal. In certain embodiments, suitable platinum alloys include alloys with cobalt, nickel, chromium, copper, titanium, gold, silver, osmium, ruthenium, iridium, rhenium, and manganese. Such electrodes are commercially available and well known to those skilled in the art.

With some balancing cells, the second electrode comprises carbon. Carbon electrodes known in the art include graphite, glassy carbon (sometime called vitreous carbon), and carbon black. Some preferred second electrodes comprise non-functionalized carbon. Such electrodes are commercially available and well known to those skilled in the art.

The disclosed systems and methods may feature electrochemical cell separators and/or membranes that have certain characteristics. In this disclosure, the terms membrane and separator are used interchangeably. The membranes of the present disclosure may, in some embodiments, feature a membrane separator having a thickness of less than about 500 micrometers, less than about 300 micrometers, less than about 250 micrometers, less than about 200 micrometers, less than about 100 micrometers, less than about 75 micrometers, less than about 50 micrometers, less than about 30 micrometers, less than about 25 micrometers, less than about 20 micrometers, or less than about 15 micrometers.

Separators are generally categorized as either solid or porous. Solid membranes typically comprise an ion-exchange membrane, wherein an ionomer facilitates mobile ion transport through the body of the polymer. The facility with which ions conduct through the membrane can be characterized by a resistance, typically an area resistance in units of Ωcm². The area resistance is a function of inherent membrane conductivity and the membrane thickness. Thin membranes are desirable to reduce inefficiencies incurred by ion conduction and therefore can serve to increase voltage efficiency of the energy storage device. Active material crossover rates are also a function of membrane thickness, and typically decrease with increasing membrane thickness. Crossover represents a current efficiency loss that must be balanced with the voltage efficiency gains by utilizing a thin membrane.

Porous membranes are non-conductive membranes which allow charge transfer between two electrodes via open channels filled with conductive electrolyte. Porous membranes are permeable to liquid or gaseous chemicals. This permeability increases the probability of chemicals passing through the porous membrane from one electrode to another causing cross-contamination and/or reduction in cell energy efficiency. The degree of this cross-contamination depends on, among other features, the size (the effective diameter and channel length), and character (hydrophobicity/hydrophilicity) of the pores, the nature of the electrolyte, and the degree of wetting between the pores and the electrolyte.

Such ion-exchange separators may also comprise membranes, which are sometimes referred to as polymer electrolyte membrane (PEM) or ion conductive membrane (ICM). The membranes according to the present disclosure may comprise any suitable polymer, typically an ion exchange resin, for example comprising a polymeric anion or cation exchange membrane, or combination thereof. The mobile phase of such a membrane may comprise, and/or is responsible for the primary or preferential transport (during operation of the battery) of at least one mono-, di-, tri-, or higher valent cation and/or mono-, di-, tri-, or higher valent anion, other than protons or hydroxide ions.

Additionally, substantially non-fluorinated membranes that are modified with sulfonic acid groups (or cation exchanged sulfonate groups) may also be used. Such membranes include those with substantially aromatic backbones, e.g., poly-styrene, polyphenylene, bi-phenyl sulfone (BPSH), or thermoplastics such as polyetherketones or polyethersulfones. Examples of ion-exchange membranes include Nafion®.

Battery-separator style porous membranes, may also be used. Because they contain no inherent ionic conduction capability, such membranes are typically impregnated with additives in order to function. These membranes are typically comprised of a mixture of a polymer, and inorganic filler, and open porosity. Suitable polymers include those chemically compatible with the electrolytes of the presently described systems, including high density polyethylene, polypropylene, polyvinylidene difluoride (PVDF), or polytetrafluoroethylene (PTFE). Suitable inorganic fillers include silicon carbide matrix material, titanium dioxide, silicon dioxide, zinc phosphide, and ceria and the structures may be supported internally with a substantially non-ionomeric structure, including mesh structures such as are known for this purpose in the art.

The methods are flexible in their utility with a range of redox couples and electrolytes, including those couples comprising a metal or metalloid of Groups 2-16, including the lanthanide and actinide elements; for example, including those where the redox couple comprises Al, As, Ca, Ce, Co, Cr, Cu, Fe, Mg, Mn, Mo, Ni, Sb, Se, Si, Sn, Ti, V, W, Zn, or Zr, including coordination compounds of the same, and either with aqueous or non-aqueous electrolyte solutions.

It should be appreciated that, while the various embodiments described herein are described in terms of flow battery systems, the same strategies and design/chemical embodiments may also be employed with stationary (non-flow) electrochemical cells, batteries, or systems, including those where one or both half cells employ stationary electrolytes. Each of these embodiments is considered within the scope of the present invention.

### TERMS

Throughout this specification, words are to be afforded their normal meaning, as would be understood by those skilled in the relevant art. However, so as to avoid misunderstanding, the meanings of certain terms will be specifically defined or clarified.

As used herein, the term “redox couple” is a term of the art generally recognized by the skilled electrochemist and refers to the oxidized (electron acceptor) and the reduced (electron donor) forms of the species of a given redox reaction. Preferably, substantially reversible couples are utilized. The pair Fe(CN)₆³⁺/Fe(CN)₆⁴⁺ is but one, non-limiting, example of a redox couple. Similarly, the term “redox active metal ion” is intended to connote that the metal undergoes a change in oxidation state under the conditions of use. As used herein, the term “redox couple” may refer to pairs of organic or inorganic materials. As described herein, inorganic materials may include “metal ligand coordination compounds” or simply “coordination compounds” which are also known to those skilled in the art of electrochemistry and inorganic chemistry. A (metal ligand) coordination compound may comprise a metal ion bonded to an atom or molecule. The bonded atom or molecule is referred to as a “ligand”. In certain non-limiting embodiments, the ligand may comprise a molecule comprising C, H, N, and/or O atoms. In other words, the ligand may comprise an organic molecule. In some embodiments of the present inventions, the coordination compounds comprise at least one ligand that is not water, hydroxide, or a halide (F⁻, Cl⁻, Br⁻, I⁻), though the invention is not limited to these embodiments. Additional embodiments include those metal ligand coordination compounds described in U.S. patent application Ser. No. 13/948,497, filed Jul. 23, 2013, which is incorporated by reference herein in its entirety at least for its teaching of coordination compounds

Unless otherwise specified, the term “aqueous” refers to a solvent system comprising at least about 98% by weight of water, relative to total weight of the solvent. In some applications, soluble, miscible, or partially miscible (emulsified with surfactants or otherwise) co-solvents may also be usefully present which, for example, extend the range of water's liquidity (e.g., alcohols/glycols). When specified, additional independent embodiments include those where the “aqueous” solvent system comprises at least about 55%, at least about 60 wt %, at least about 70 wt %, at least about 75 wt %, at least about 80%, at least about 85 wt %, at least about 90 wt %, at least about 95 wt %, or at least about 98 wt % water, relative to the total solvent. It some situations, the aqueous solvent may consist essentially of water, and be substantially free or entirely free of co-solvents or other species. The solvent system may be at least about 90 wt %, at least about 95 wt %, or at least about 98 wt % water, and, in some embodiments, be free of co-solvents or other species. Unless otherwise specified, the term “non-aqueous” refers to a solvent system comprising less than 10% by weight of water, generally comprising at least one organic solvent. Additional independent embodiments include those where the “non-aqueous” solvent system comprises less than 50%, less than 40 wt %, less than 30 wt %, less than 20 wt %, less than 10%, less than 5 wt %, or less than 2 wt % water, relative to the total solvent.

In addition to the redox active materials, an aqueous electrolyte may contain additional buffering agents, supporting electrolytes, viscosity modifiers, wetting agents, and the like.

As used herein, the terms “negative electrode” and “positive electrode” are electrodes defined with respect to one another, such that the negative electrode operates or is designed or intended to operate at a potential more negative than the positive electrode (and vice versa), independent of the actual potentials at which they operate, in both charging and discharging cycles. The negative electrode may or may not actually operate or be designed or intended to operate at a negative potential relative to the reversible hydrogen electrode. The negative electrode is associated with the first aqueous electrolyte and the positive electrode is associated with the second electrolyte, as described herein.

The terms “negolyte” and “posolyte,” as used herein, refer to the electrolytes associated with the negative electrode and positive electrodes, respectively.

As used herein, unless otherwise specified, the term “substantially reversible couples” refers to those redox pairs wherein the voltage difference between the anodic and cathodic peaks is less than about 0.3 V, as measured by cyclic voltammetry, using an ex-situ apparatus comprising a flat glassy carbon disc electrode and recording at 100 mV/s. However, additional embodiments provide that this term may also refer to those redox pairs wherein the voltage difference between the anodic and cathodic peaks is less than about 0.2 V, less than about 0.1 V, less than about 0.075 V, or less than about 0.059 V, under these same testing conditions. The term “quasi-reversible couple” refers to a redox pair where the corresponding voltage difference between the anodic and cathodic peaks is in a range of from 0.3 V to about 1 V.

The terms “separator” and “membrane” refer to an ionically conductive, electrically insulating material disposed between the positive and negative electrode of an electrochemical cell.

The term “stack” or “cell stack” or “electrochemical cell stack” refers to a collection of individual electrochemical cells that are in electrically connected. The cells may be electrically connected in series or in parallel. The cells may or may not be fluidly connected.

The term “state of charge” (SOC) is well understood by those skilled in the art of electrochemistry, energy storage, and batteries. The SOC is determined from the concentration ratio of reduced to oxidized species at an electrode (X_{red}/Xₒₓ). For example, in the case of an individual half-cell, when X_{red}=Xₒₓ such that X_{red}/Xₒₓ=1, the half-cell is at 50% SOC, and the half-cell potential equals the standard Nernstian value, E°. When the concentration ratio at the electrode surface corresponds to X_{red}/Xₒₓ=0.25 or X_{red}/Xₒₓ=0.75, the half-cell is at 25% and 75% SOC respectively. The SOC for a full cell depends on the SOCs of the individual half-cells and in certain embodiments the SOC is the same for both positive and negative electrodes. Measurement of the cell potential for a battery at its open circuit potential, the ratio of X_{red}/Xₒₓ at each electrode can be determined, and therefore the SOC for the battery system.

The term “bipolar plate” refers to an electrically conductive, substantially nonporous material that may serve to separate electrochemical cells in a cell stack such that the cells are connected in series and the cell voltage is additive across the cell stack. The bipolar plate has two surfaces such that one surface of the bipolar plate serves as a substrate for the positive electrode in one cell and the negative electrode in an adjacent cell. The bipolar plate typically comprises carbon and carbon containing composite materials.

### EXAMPLES

The following Examples are provided to illustrate some of the concepts described within this disclosure. While each Example is considered to provide specific individual embodiments of composition, methods of preparation and use, none of the Examples should be considered to limit the more general embodiments described herein.

### Example 11

### Materials

Sodium hexacyanoferrate(II) decahydrate 99%, Na₄Fe(CN)₆·10H₂O; potassium hexacyanoferrate(II) trihydrate 98+%, K₄Fe(CN)₆·3H₂O; potassium hexacyanoferrate(III) ACS 99.0% min; K₃Fe(CN)₆; were purchased from Alfa Aesar (Ward Hill, Mass.) as ACS grade or better unless specified above and were used without additional purification.

The mixed ligand titanium complexes sodium potassium titanium(IV) biscatecholate monopyrogallate, sodium potassium titanium(IV) biscatecholate-monolactate, sodium potassium titanium (IV) biscatecholate monogluconate, sodium potassium titanium(IV) biscatecholate monoascorbate, and sodium potassium titanium(IV) bis catecholate monocitrate were prepared from a titanium catecholate dimer, Na₂K₂[TiO(catecholate)₂]₂. For the synthesis of the tetrapotassium salt see Borgias, B. A.; Cooper, S. R.; Koh, Y. B.; Raymond, K. N. Inorg. Chem. 1984, 23, 1009-1016. A one-to-one mixture of titanium dimer with the desired chelate (pyrogallol, lactic acid, gluconic acid, ascorbic acid, or citric acid) gave the mixed ligand species. Sodium potassium titanium(IV) monocatecholate monopyrogallate monolactate was made in a similar fashion by addition of both pyrogallol and lactic acid to the catecholate containing dimer. Mixed ligand analogs of the Al, Cr, Fe, and Mn compounds may be prepared by similar reaction schemes.

Non-limiting examples of posolyte and negolyte solutions useful for demonstrating the present invention are described herein. For the posolyte an equimolar mixture of Na₄Fe(CN)₆·10H₂O and K₄Fe(CN)₆·3H₂O salts are dissolved in aqueous solution to give a total Fe(CN)₆ ion concentration of 1 to 1.5 M. The solution is then adjusted to pH 11 with 0.1 M phosphate buffer and 0.025 M Na₄EDTA is added. For the negolyte 1 to 1.5 M aqueous solutions of NaKTi(catecholate)₂(pyrogallate) were prepared and adjusted to pH 11 prior to use.

### Example 12

### Experimental Procedure for the Preparation of a 25 cm² Active Area Flow Battery

The present invention involves the use of two electrochemical cells, a primary electrochemical cell that accomplishes the charge/discharge functions of the energy storage device, and a secondary cell, that maintains electrolyte SOC balance in the primary cell. The secondary cell, in the present invention takes the form of a driven, hydrogen scavenging cell that can be coupled to the battery system to circumvent electrolyte imbalance that may occur during operation of the primary cell.

A non-limiting example of a primary cell of the present invention is described herein. Cell hardware designed for 25 cm² active area and modified for acid flow was obtained from Fuel Cell Technologies (Albuquerque, N. Mex.). MGL 370 carbon paper was obtained from Fuel Cell Earth (Stoneham, Mass.), was spray coated with an suspension composed of Mogul-L high surface area carbon (Cabot Corp., Boston, Mass.) and NAFION™ (Ion-Power, New Castle, Del.) and air-dried before use. NAFION™ HP, XL, or NR-212 cation exchange membranes were obtained from Ion-Power in the H⁺ form and were used as received. VITON™ o-rings were obtained from McMaster Carr (Robinsville, N.J.). The membranes and electrodes were not pretreated before assembly. A gas tight battery system was composed of the primary cell, electrolyte pumps, and custom built electrolyte reservoirs. The electrolyte reservoirs were fashioned from Schedule 80 PVC piping with PVDF tubing and compression fittings. Masterflex™ L/S peristaltic pumps (Cole Parmer, Vernon Hills, Ill.) were used with Tygon™ tubing. Pumps from Iwaki America (Holliston, Mass.) were used to flow electrolyte through the flow battery cell. Electrolytes were sparged with UHP argon prior to electrochemical testing. An Arbin Instruments BT2000 (College Station, Tex.) was used to test the electrochemical performance, and a Hioki 3561 Battery HiTESTER (Cranbury, N.J.) was used to measure the AC resistance across the cell.

### Example 1.3

### Experimental Procedure for the Preparation of a 25 cm² Active Area Balancing Cell

A non-limiting example of a secondary or balancing cell, for use in the present invention is described herein. Cell hardware designed for 25 cm² active area and modified for acid flow is obtained from Fuel Cell Technologies (Albuquerque, N. Mex.). Membrane electrode assemblies composed of NR-212 cation exchange membranes coated on a single side with a catalyst Pt/C layer with a Pt loading of 0.3 mg/cm² is used (Ion-Power, New Castle, Del.). The gaseous electrode utilizes Teflon coated Toray 120 hydrophobic gas diffusion layer materials, and the liquid electrode utilizes MGL370 carbon paper, both available from Fuel Cell Earth (Stoneham, Mass.). A gas blower from Barber-Nichols (Arvada, Colo.) can be used to circulate the headspace gas mixture through hydrogen scavenging cell. An Arbin Instruments BT2000 (College Station, Tex.) is used to test the electrochemical performance and to control the balancing cell.

### Example 2

### Operating a Flow Battery Cell without an Integrated Balancing Cell

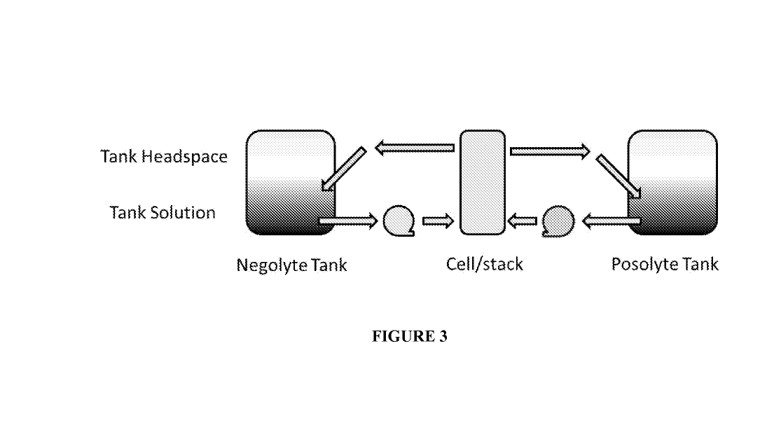

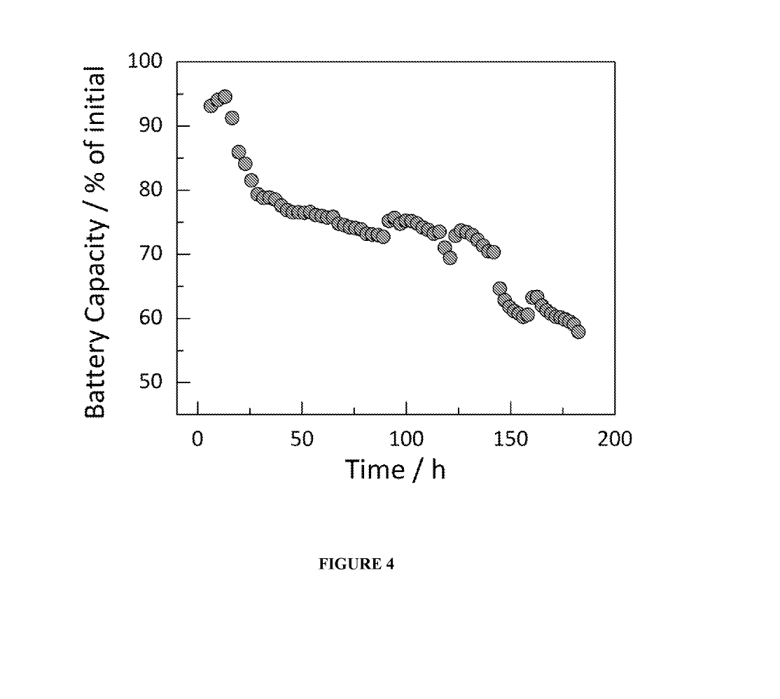

A redox flow battery cell without an integrated balancing cell was assembled according to the methods described in Example 1.3, FIG. 3. Titanium bis catecholate monopyrogallate (Ti(cat)₂(gal)²⁻) and ferrocyanide (Fe(CN)₆⁴⁻) metal ligand coordination compounds were used as active materials for the negative and positive electrolytes, respectively. The active materials were prepared at concentrations of 1.5 M, loaded into separate storage vessels, sparged with argon for 20 minutes, and were flowed at 150 mL/min through the flow battery cell assembled using 25 cm² carbon paper electrodes and a NAFION™ cation selective membrane (50 μm thick) in Na⁺ form. The cell was initially charged from 0 to 50% state of charge and an OCV measurement collected. Charge/discharge cycles were then collected by sweeping the cell SOC from 20% to 80% at a current density of 200 mA/cm². The cell OCV was measured at 20% SOC and 80% SOC during each cycle. Under these conditions the OCV is observed to drop after several cycles due to electrolyte imbalance as a result of hydrogen evolution, FIG. 4.

### Example 3

### Operating a Flow Battery Cell with an Integrated Balancing Cell

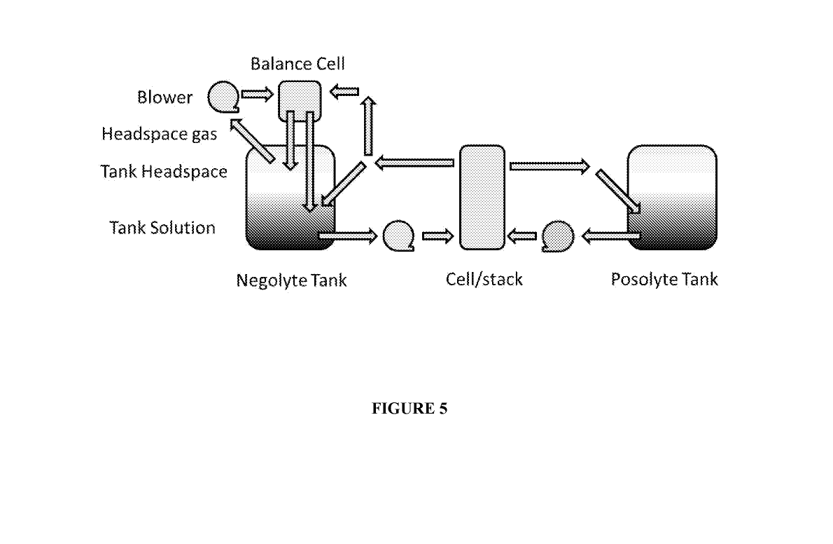

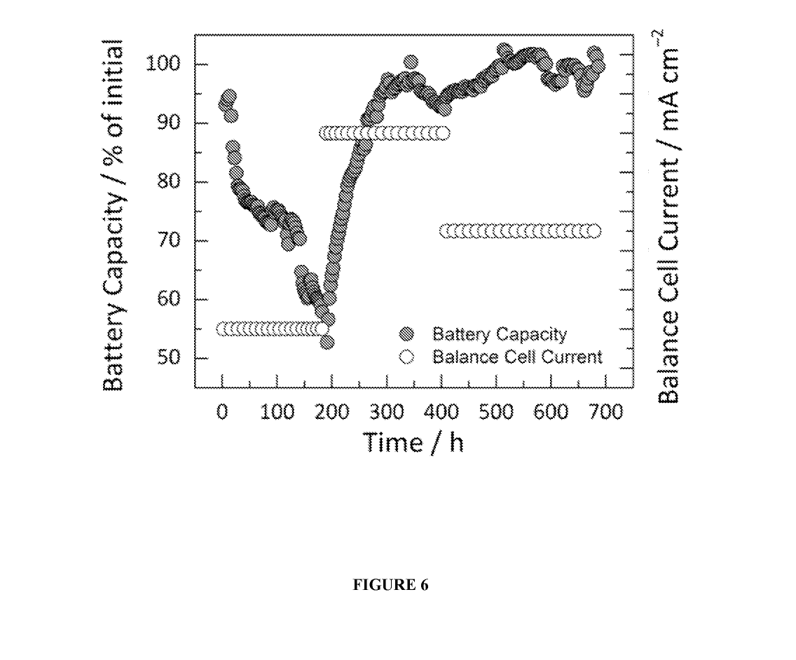

A redox flow battery is assembled according to the methods described in Example 1.2 and was integrated with a balancing cell assembled according to the methods of Example 1.3. The flow battery cell and balancing cell are integrated with one another according to the schematic shown in FIG. 5. In brief the liquid side of the balancing cell is connected to the liquid loop of the flow battery cell, and the gaseous side of the balancing cell is connected to the electrolyte reservoir headspace. Fluid pumping through the balancing cell is affected by the negolyte pump, and gas flow through the gaseous side is affected by the blower unit. The flow battery cell is operated according to the methods of Example 2. The balancing cell is maintained at a constant potential of 1 V and the current is monitored during the course of cycling the primary cell, FIG. 6. Under these conditions the OCV of the flow battery is maintained over several cycles, indicating that the posolyte and negolyte SOCs are in balance.

As those skilled in the art will appreciate, numerous modifications and variations of the present invention are possible in light of these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

The disclosures of each patent, patent application, and publication cited or described in this document are hereby incorporated herein by reference, each in its entirety, for all purposes.

What is claimed:

1. A redox flow battery comprising one or more electrochemical cells in fluid contact with an electrochemical balancing cell, said electrochemical balancing cell comprising:
a first electrode comprising a gas diffusion electrode and said first electrode comprising a hydrogen oxidation catalyst, said first electrode being maintained at a potential more positive than a thermodynamic potential for hydrogen evolution;
a second electrode, said second electrode contacting a negative electrolyte, and said second electrode being maintained at a potential sufficiently negative to reduce the negative electrolyte;
a membrane disposed between said first electrode and said second electrode, said membrane suitable to allow hydrogen cations to flow from the membrane to the negative electrolyte; and
a means for contacting hydrogen with said first electrode.

2. The redox flow battery of claim 1, wherein said hydrogen oxidation catalyst comprises one or more precious metals.

3. The redox flow battery of claim 2, wherein said one or more precious metals comprise platinum or platinum containing alloys.

4. The redox flow battery of claim 1, wherein said second electrode comprises carbon.

5. The redox flow battery of claim 4, wherein said second electrode comprises non-functionalized carbon.

6. The redox flow battery of claim 1, wherein said membrane is an ion selective membrane.

7. The redox flow battery of claim 1, additionally comprising a power supply to supply energy to said first and second electrodes, said energy being sufficient to drive the balancing cell.

8. The redox flow battery of claim 1, wherein the first electrode is maintained at a potential to avoid corrosion of the hydrogen oxidation catalyst in the first electrode.

9. The redox flow battery of claim 1, wherein said means for contacting hydrogen with said first electrode utilizes hydrogen from head space gas of said one or more electrochemical cells as at least a portion of said hydrogen.

10. A method for balancing the state of charge of a flow battery, said method comprising:
obtaining a hydrogen-containing gas, optionally produced as a byproduct of said flow battery;
contacting said hydrogen-containing gas with a first electrode, said first electrode comprising carbon functionalized with a hydrogen oxidation catalyst, and said first electrode being maintained at a potential that is more positive than a thermodynamic potential for hydrogen evolution;
contacting a negative electrolyte with a second electrode, said second electrode being maintained at a potential sufficiently negative to reduce the negative electrolyte; and
applying a voltage to said first and second electrodes in an amount sufficient to drive said balancing;
wherein said first and second electrodes are separated by a membrane disposed between said first electrode and said second electrode, said membrane suitable to allow hydrogen cations to flow from the membrane to the negative electrolyte.

11. The method of claim 10, wherein said hydrogen oxidation catalyst comprises one or more precious metals.

12. The method of claim 11, wherein said one or more precious metals comprises platinum or platinum alloys.

13. The method of claim 10, wherein said second electrode comprises carbon.

14. The method of claim 13, wherein said second electrode comprises non-functionalized carbon.

15. The method of claim 10, wherein said membrane is an ion selective membrane.

16. The method of claim 10, wherein at least a portion of said hydrogen-containing gas is obtained as a byproduct of said flow battery.
